(19) United States
(12) Patent Application Publication
(10) Pub. No.: US 2023/0176552 A1
(43) Pub. Date: Jun. 8, 2023

(54) REINFORCEMENT LEARNING-BASED OPTIMIZATION OF MANUFACTURING LINES

(71) Applicant: MICROSOFT TECHNOLOGY LICENSING, LLC, Redmond, WA (US)

(72) Inventors: Kartavya NEEMA, San Ramon, CA (US); Amir Hossein JAFARI, Emeryville, CA (US); Brice Hoani Valentin CHUNG, Oakland, CA (US)

(21) Appl. No.: 17/541,177

(22) Filed: Dec. 2, 2021

(51) Int. Cl. G05B 19/418; G06K 9/62

(52) U.S. Cl. CPC G05B 19/41865; G05B 19/41885; G06K 9/6262

(57) ABSTRACT

Technologies for reinforcement learning-based optimization of manufacturing lines are disclosed. A reinforcement learning-based selector is trained utilizing reinforcement learning to select a reinforcement learning-based controller for controlling the operation of machines on a manufacturing line. The selection can be made based upon inputs from the machines on the manufacturing line indicating whether machines on the line are jammed, whether the manufacturing line is operating at a steady state, or other conditions. The selected reinforcement learning-based controller can generate outputs to adjust parameters of the machines on the manufacturing line, such as operating speed, in order to recover from the jamming of one or more machines, to transition to a steady state of operation, or to operate the manufacturing line in a steady state of operation. The selector and the reinforcement learning-based controllers can be trained using reinforcement learning on a simulation of the manufacturing line.

### BACKGROUND

Manufacturing lines, which might also be referred to herein as production lines, can be configured in various ways. One common configuration for a manufacturing line moves items being manufactured sequentially along the line between machines using conveyors or other mechanisms.

Machines or workstations located periodically along a manufacturing line perform various types of operations on the items being manufactured. For example, machines might be located along a manufacturing line for packaging, labeling, cleaning, filling, washing, painting, or performing other types of operations on items being manufactured. Manufacturing lines configured in this manner are highly suited to manufacturing a single product that has few or no variations.

Optimizing the efficiency of manufacturing lines such as those described above, and others, can be extremely challenging due to the many variables present in different types of manufacturing processes. For instance, machines operating on manufacturing lines can have many settings, including a speed of operation setting. Machines on manufacturing lines can also periodically become jammed or otherwise malfunction. Conveyors and other components on manufacturing lines can also have their own settings and can also periodically malfunction or become inoperable, which reduces the efficiency of the manufacturing lines.

Current processes for operating many types of manufacturing lines, such as those described above, commonly rely on manual input from operators to deal with jammed or malfunctioning machines and to keep manufacturing lines operating in an efficient fashion. For example, when a machine on a manufacturing line becomes jammed, a human operator might manually adjust the speed of operation of another machine that is upstream (i.e., at an earlier location in the manufacturing process) from the jammed machine in order to slow the influx of items into the jammed machine while the operator addresses the jam.

These types of manual adjustments are typically made only to machines in close proximity to the operator and, as a result, change only the operating speed or other parameters of machines proximate to a jammed or otherwise inoperable machine. Consequently, manual adjustments such as these that are made in response to jams or other malfunctions on a manufacturing line are typically sub-optimal. This can result manufacturing lines operating in an inefficient manner, and thereby cause the lines to produce fewer items than they are otherwise capable of. Moreover, manual adjustments such as these might cause other types of inefficiencies, such as machines operating and consuming power when they could otherwise be slowed to conserve power.

It is with respect to these and other technical challenges that the disclosure made herein is presented.

### SUMMARY

Technologies are disclosed for reinforcement learning-based optimization of manufacturing lines. Through implementations of the disclosed technologies, operating parameters, such as the operating speed, of machines on a manufacturing line can be adjusted in an automated fashion when one or machines on the line are jammed or at other times to optimize the output of the manufacturing line. The technologies disclosed herein might also save power by slowing the operating speed of machines on a manufacturing line at certain times such as when a machine on the line is jammed or otherwise malfunctioning. Other technical benefits not specifically mentioned herein can also be realized through implementations of the disclosed subject matter.

In order to realize the technical benefits mentioned briefly above, and potentially others, a manufacturing line simulator is created that models the operation of a physical manufacturing line as a virtual environment. The manufacturing line simulator might be created in an appropriate programming or simulation environment. For example, in one particular embodiment, the manufacturing line simulator is created using the PYTHON programming language. Other types of programming or simulation environments can be utilized in other embodiments.

The manufacturing line simulator can be utilized as a virtual environment in conjunction with a reinforcement learning training platform to utilize reinforcement learning techniques to train a reinforcement-learning based manufacturing line controller that learns to control several aspects of a manufacturing line. As will be described in greater detail below, the reinforcement learning-based manufacturing line controller can be executed on an industrial controller, or another type of computing device communicatively coupled to the machines on a manufacturing line to control various aspects of the operation of the machines. For example, and without limitation, the reinforcement learning-based manufacturing line controller can be trained to adjust the operating speeds or other parameters of machines on the manufacturing line to optimize the output of the manufacturing line.

In one particular embodiment, the reinforcement learning-based manufacturing line controller includes a reinforcement learning-based selector, a reinforcement learning-based steady state controller, a reinforcement learning-based transient state controller, and a reinforcement learning-based jammed state controller. The reinforcement learning-based steady state controller, the reinforcement learning-based transient state controller, and the reinforcement learning-based jammed state controller are also trained using the manufacturing line simulator as a virtual environment and the reinforcement learning training platform. As will be described in greater detail below, the reinforcement learning-based selector is trained using reinforcement learning to utilize inputs received from the machines on the manufacturing line to select one of the controllers identified above at a given time to optimize the operation of the manufacturing line.

Once the reinforcement learning-based manufacturing line controller has been trained, it can be deployed to an industrial controller or another type of computing device that is communicatively coupled to the machines on a physical manufacturing line. Once deployed, the reinforcement learning-based manufacturing line controller can be executed on the industrial controller and begin receiving inputs from the machines, conveyors, sensors, and potentially other components on the manufacturing line. The inputs indicate aspects of the operating state of the manufacturing line. For example, and without limitation, the reinforcement learning-based manufacturing line controller might receive inputs indicating the actual operating speed of the machines on the line, the status of the machines on the line (e.g. whether a machine is jammed or otherwise malfunctioning), the estimated number of items at various locations on conveyor belts in the manufacturing line, the status of various sensors on the manufacturing line, and other types of data.

In response to receiving inputs such as those described above, the reinforcement learning-based selector selects one of the reinforcement learning-based controllers described above for controlling the operation of the machines on the manufacturing line based on the inputs. For example, and without limitation, the reinforcement learning-based selector might select the reinforcement learning-based steady state controller, the reinforcement learning-based transient state controller, or the reinforcement learning-based jammed state controller to control the operation of the manufacturing line at a given time based upon the inputs.

Once the reinforcement learning-based selector has selected one of the reinforcement learning-based controllers, the selected controller is executed on the industrial controller. In operation, the selected controller generates outputs to adjust parameters (e.g., an output indicating operating speeds machines on the manufacturing line) for controlling the operation of the machines on the manufacturing line.

The reinforcement learning-based selector continually monitors inputs generated by the manufacturing line to ensure that the most optimal reinforcement learning-based controller is being utilized to control the operation of the line at any given time. For example, and without limitation, if the reinforcement learning-based selector receives an input indicating that one or more of the machines on the manufacturing line is jammed or otherwise malfunctioning, the reinforcement learning-based selector will select the reinforcement learning-based jammed state controller for controlling the operation of the machines on the line. The reinforcement learning-based jammed state controller is configured to generate outputs that are provided as inputs to the machines on the manufacturing line to adjust the operating speed of one or more of the machines on the manufacturing line until none of the machines on the manufacturing line is jammed or otherwise malfunctioning.

Similarly, if the reinforcement learning-based selector receives inputs indicating that none of the machines on the manufacturing line is jammed or otherwise malfunctioning but that the manufacturing line is not operating in a steady state of operation, the reinforcement learning-based selector will select the reinforcement learning-based transient state controller for controlling the operation of the machines on the line. The reinforcement learning-based transient state controller generates outputs that are provided as inputs to one or more of the machines on the manufacturing line instructing them to adjust their operating speed until the manufacturing line is operating in the steady state of operation.

If the reinforcement learning-based selector receives inputs indicating that none of the machines on the manufacturing line is jammed or otherwise malfunctioning and the manufacturing line is operating in a steady state of operation, the reinforcement learning-based selector will select the reinforcement learning-based steady controller. This controller is configured to maintain operation of the manufacturing line in the steady state of operation until a jam, malfunction, or another event occurs that causes the manufacturing line to stop operating in the steady state of operation. If such an event occurs, the reinforcement learning-based selector will select a new controller for controlling the operation of the manufacturing line based upon the current state of the inputs.

As discussed briefly above, implementations of the technologies disclosed herein can enable more efficient operation of manufacturing lines, thereby enabling their output to be optimized. Power savings might also be realized by slowing the operation of machines on a manufacturing line using the disclosed technologies. Other technical benefits not specifically identified herein can also be realized through implementations of the disclosed technologies.

It should be appreciated that the above-described subject matter can be implemented as a computer-controlled apparatus, a computer-implemented method, a computing device, or as an article of manufacture such as a computer readable medium. These and various other features will be apparent from a reading of the following Detailed Description and a review of the associated drawings.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A is a manufacturing line diagram that shows aspects of a manufacturing line that might form an operating environment for the disclosed technologies, according to embodiments disclosed herein;

FIG. 1B is a manufacturing line diagram that shows aspects of another configuration for a manufacturing line that might form an operating environment for the disclosed technologies, according to embodiments disclosed herein;

FIG. 2 is a manufacturing line diagram that shows aspects of one current mechanism that utilizes manual input by a machine operator to resolve jammed or malfunctioning machines to keep a manufacturing line operating in an optimal fashion;

FIG. 3 is a software architecture diagram illustrating aspects of reinforcement learning-based training of a reinforcement learning-based manufacturing line controller, according to one embodiment disclosed herein;

FIG. 4 is a state diagram illustrating aspects of the operation of a reinforcement learning-based manufacturing line controller, including a reinforcement learning-based selector for selecting a reinforcement learning-based controller for controlling the operation of the machines on a manufacturing line, according to one em-bodiment disclosed herein;

FIG. 5 is a manufacturing line diagram that shows aspects of a manufacturing line that incorporates aspects of the technologies disclosed herein for reinforcement learning-based control of a manufacturing line, according to one embodiment disclosed herein;

FIG. 6 is a flow diagram showing a routine that illustrates aspects of the mechanism shown in FIG. 3 for reinforcement learning-based training of a reinforcement learning-based manufacturing line controller, according to one embodiment disclosed herein;

FIG. 7 is a flow diagram showing a routine that illustrates aspects of the mechanism shown in FIG. 5 for operating a manufacturing line utilizing a reinforcement learning-based manufacturing line controller, according to one embodiment disclosed herein; and

FIG. 8 is a computer architecture diagram showing an illustrative com-puter hardware and software architecture for a computing device that can implement aspects of the technologies presented herein.

### DETAILED DESCRIPTION

The following detailed description is directed to technologies for reinforcement learning-based optimization of manufacturing lines. As discussed briefly above, implementations of the technologies disclosed herein can enable operating parameters, such as the operating speed, of machines on a manufacturing line to be ad-justed in an automated fashion when a machine on the line is jammed or at other times to optimize the output of the manufacturing line. The technologies disclosed herein might also save power by slowing the operating speed of machines on a manufacturing line at certain times such as when a machine on the line is jammed or otherwise malfunctioning. Other technical benefits not specifically mentioned herein can also be realized through implementations of the disclosed subject matter.

While the subject matter described herein is presented in the general context of an industrial controller executing a reinforcement learning-trained controller to control aspects of the operation of a manufacturing line, those skilled in the art will recognize that other implementations can be performed in combination with other types of computing systems and modules. Those skilled in the art will also appreciate that the subject matter described herein can be practiced with other computer system configurations, including, multiprocessor systems, microprocessor-based or programmable consumer electronics, computing or processing systems embedded in devices, mini-computers, mainframe computers, and the like.

In the following detailed description, references are made to the accom-panying drawings that form a part hereof, and which are shown by way of illustration specific configurations or examples. Referring now to the drawings, in which like nu-merals represent like elements throughout the several FIGS., aspects of various technologies for reinforcement learning-based optimization of manufacturing lines will be described.

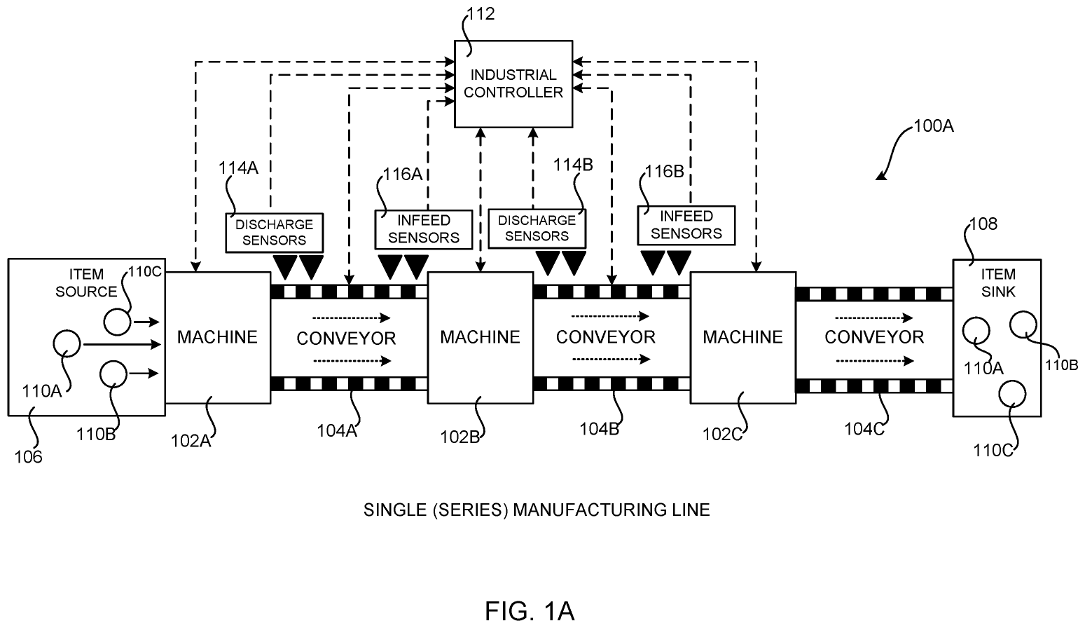

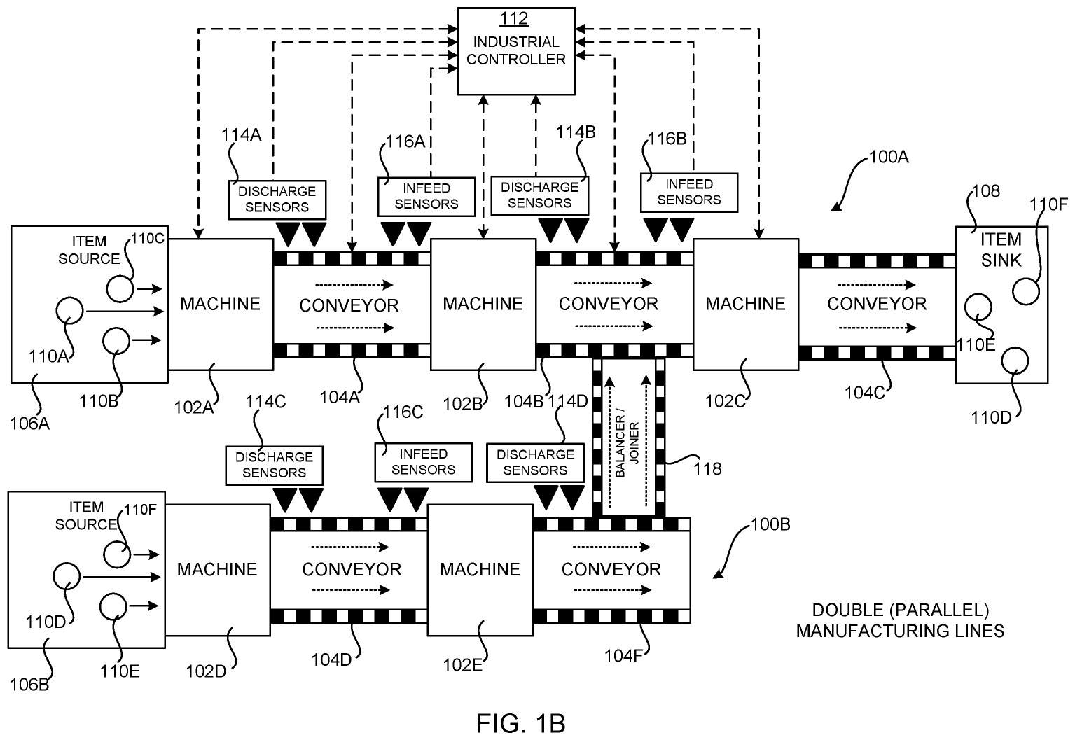

FIG. 1A is a manufacturing line diagram that shows aspects of a manufacturing line 100A that might form an operating environment for the disclosed technologies, according to embodiments disclosed herein. As discussed briefly above, manufacturing lines such as the manufacturing line 100A, which might also be referred to herein as simply “lines” or “production lines,” can be configured in various ways. One common configuration for a manufacturing line 100A is shown in FIG. 1A. In this configuration, the manufacturing line 100A moves items 110A-110C being manufactured sequentially along the line 100A (from left to right in the illustration shown in FIG. 1A) using conveyors 104 or other mechanisms. This type of configuration is commonly referred to as a series manufacturing line.

Machines 102A-102C or workstations located periodically along the manufacturing line 100A perform various types of operations on the items 110 being manufactured. For example, machines 102 might be located along the manufacturing line 100A that provide functionality for packaging, labeling, cleaning, filling, washing, painting, spraying, trimming, printing, or performing other types of operations on the items 110 being manufactured.

In the specific configuration of the manufacturing line 100A shown in FIG. 1A, items 110 being manufactured or otherwise operated upon enter the manufacturing line 100A at an item source 106. In the illustrated example, for instance, the items 110A-110C are present at the item source 106. The items 110A-110C enter a machine 102A that is configured to perform one or more operations on the items 110A-110C, some examples of which were described above. Once the machine 102A has finished operating on the items 110A-110C, the items 110A-110C exit the machine 102A and are placed onto a conveyor 104A. The conveyor 104A moves the items 110 to the next machine 102B on the manufacturing line 100A.

The machine 102B operates on the items 110A-110C and then places the items 110A-110C on the conveyor 104B. In a similar fashion, the machine 102C operates on the items 110A-110C as they come off of the conveyor 104B and then places the items 110A-110C on a conveyor 104C for final delivery to a destination, referred to herein as an item sink 108.

As mentioned briefly above, the configuration shown in FIG. 1A is commonly referred to as a series manufacturing line since items 110 progress through the machines 102 in the manufacturing line 100A in series fashion. As will be described below, other configurations can be utilized to implement a manufacturing line.

As also shown in FIG. 1A, an industrial controller 112 is communicatively coupled (as illustrated by the dashed lines in FIG. 1A) to the machines 102 and the conveyors 104 in order to monitor and control the operation of the manufacturing line 100A. The industrial controller 112 might take the form of a programmable logic controller (“PLC”), a supervisory control and data acquisition (“SCADA”) controller, a discrete controller, a distributed control system (“DCS”), an industrial controller, or another type of computing device configured to monitor and control the operation of the various machines 102, conveyors 104, and other components on a manufacturing line 100A.

As also shown in FIG. 1A, the conveyors 104 are equipped with discharge sensors 114 and infeed sensors 116 (which might be referred to collectively as “proximity sensors” or just “sensors”) in some configurations. The discharge sensors 114 provide a binary signal to the industrial controller 112 in some embodiments indicating that one or more items 110 are present (e.g. a binary one) or not present (e.g. a binary zero) at the location of the discharge sensor 114.

For example, the discharge sensors 114A can be configured to provide a binary signal to the industrial controller 112 based upon whether one or more items 110 are present at the output of the machine 102A. Similarly, the discharge sensors 114B are configured to provide a binary signal to the industrial controller 112 indicating whether one or more items 110 are present at the output of the machine 102B. Although not shown, discharge sensors 114 might also be present at the output of the machine 102C to provide an indication to the industrial controller 112 indicating that items are present at the output of that machine.

In a similar fashion, the infeed sensors 116A are configured to provide a binary signal to the industrial controller 112 indicating whether one or more items 110 are present (e.g. a binary one) or not present (e.g. a binary zero) at the intake to the machine 102B. Likewise, the infeed sensors 116B are configured to provide a binary signal to the industrial controller 112 indicating that one or more items 110 are present or not present at the intake to the machine 102C. In this regard, it is to be appreciated that a sensor can be located at any position along a conveyor 104 and return a signal indicating whether an items 110, or items 110, is present at the particular location of the sensor.

Although the discharge sensors 114 and infeed sensors 116 are primarily described herein as providing binary signals to the industrial controller 112, other types of signals indicating the presence or absence of items 110 at the relevant location can be provided in other embodiments. In some embodiments, the signals provided by the sensors 114 and 116 are processed through a KALMAN filter or another type of filter or estimator to generate an estimate of the number of items 110 at a particular location on a conveyor 104.

As described briefly above, the industrial controller 112 is communicatively coupled (as illustrated by the dashed lines in FIG. 1A) to the machines 102 and the conveyors 104 of the conveyor line 100A. These connections can be implemented by various types of industrial buses suitable for enabling communication between the machines 102 and conveyors 104 and the industrial controller 112. Through these connections, the industrial controller 112 can obtain status information regarding the operating conditions of the machines 102 and the conveyors 104 and, likewise, provide operating instructions to the machines 102 and conveyors 104.

For example, and without limitation, a machine 102 on the manufacturing line 100 might transmit a signal to the industrial controller 112 indicating that it has jammed or is otherwise malfunctioning. In response thereto, the industrial controller 112 might transmit a signal to the jammed or malfunctioning machine 102 instructing the machine to enter an idle mode of operation so that an operator can address the jam or other type of malfunction. In response thereto, the industrial controller 112 might also transmit other types of signals to the machines 102 such as, for example, a signal indicating a desired speed of operation for a machine 102. As will be described in greater detail below, these types of signals can be utilized to optimize the operation of a manufacturing line 100, such as the manufacturing line 100A shown in FIG. 1A, the manufacturing line 100B shown in FIG. 1B below, and other types of manufacturing lines utilizing the technologies disclosed herein.

As described briefly above, the discharge sensors 114 can provide signals to the industrial controller 112 indicating the presence or absence of items 110 at various locations on a conveyor 104. The industrial controller 112 can utilize these signals in various ways. For example, and without limitation, the industrial controller 112 might utilize signals received from a discharge sensor 114 to determine if there are too many items 110 on a conveyer 104.

If there are too many items 110 on a conveyer 104, the industrial controller 112 might transmit a signal to a machine 102 on the input side of a conveyor 104 instructing the machine 102 to slow its operating speed. Although, the industrial controller 112 might transmit a signal to a machine 102 in some circumstances instructing the machine 102 to enter an idle mode of operation in which it does not process any items 110 and conserves power. In this regard, it is to be appreciated that it is generally undesirable for machines to enter the idle mode of operation because machines do not process any items when they are in the idle mode and because there could be a chance of malfunction when machines exit the idle mode. For some machines there is a high probability of malfunction upon exiting the idle mode, while for other machines the probability is lower. Therefore, while going into idle mode is undesirable, it is more tolerable for some machines than others. Once signals received from the discharge sensors 114 indicate that there is room on the conveyor 104 for more items 110, the industrial controller 112 might transmit a signal to the machine 102 instructing the machine 102 to increase its operating speed or to exit the idle mode as appropriate.

As also described briefly above, the infeed sensors 116 can also provide signals to the industrial controller 112 indicating the presence or absence of items 110 on a conveyor 104. As with signals received from the discharge sensors 114, the industrial controller 112 can utilize these signals in various ways. For example, and without limitation, the industrial controller 112 might utilize signals received from an intake sensor 114 to determine if there are too few items 110 on a conveyer 104 to warrant keeping the next machine 102 on the line in operation.

If there are too few items 110 on a conveyer 104, the industrial controller 112 might transmit a signal to a machine 102 on the exit side of a conveyor 104 instructing the machine 102 to slow its operating speed. As discussed above, although undesirable the industrial controller 112 might, in some situations, transmit a signal to a machine 102 on the exit side of a conveyor 104 instructing the machine 102 to enter an idle mode of operation in which it does not process any items 110 and conserves power. Once signals received from the infeed sensors 116 indicate that there are items 110 on the conveyor 104 to be processed, the industrial controller 112 might transmit a signal to the machine 102 instructing the machine 102 to increase its operating speed or to exit the idle mode and begin processing items 110 once again.

The machines 102 have varying operating speeds that can be controlled by the industrial controller 112 or a manual operator. For instance, the machine 102A might be capable of processing items 110 faster than the machine 102B. As another example, the machine 102B might be capable of processing items 110 faster than the machine 102C. The conveyors 104 also have varying operating speeds that can also be controlled by the industrial controller 112 or a manual operator. In general, however, the conveyors 104 are configured to run at higher speeds than the machines 102 to which they are connected. In this manner, the conveyors 104 do not pose a practical limitation on the ability of the machines 102 to process items 110 at their respective highest operating speeds.

FIG. 1B is a manufacturing line diagram that shows aspects of another manufacturing line configuration that might form an operating environment for the disclosed technologies, according to embodiments disclosed herein. In the configuration shown in FIG. 1B, the manufacturing line 100A described above operates in conjunction with a manufacturing line 100B operating in parallel thereto. The manufacturing line 100B includes an item source 106B, a machine 102D, a conveyor 104D, a machine 102E, a conveyor 104F, and a balancer/joiner 118.

In operation, items 110D-100F enter the machine 102D from the item source 106B. The machine 102D performs one or more manufacturing operations on the items 110D-110F, such as those described above, and passes the items 110D-110F onto the conveyor 104D. In turn, the conveyor 104D passes the items 110D-110F to the machine 102E, whereby the machine 102E operates on the items 110D-110F. The machine 102E passes the items 110D-110F onto the conveyor 104F which, in turn, passes the items 110D-110F onto the balancer/joiner 118. The items 110D-110F then enter the conveyor 104B and are processed by the machine 102C of the manufacturing line 100A in the manner described above, ultimately ending up on the item sink 108.

As in the example described above, discharge sensors 114C and 114D are located at the exit of the machines 102D and 102E, respectively, and infeed sensors 116C are located at the entry to the machine 102E. Additionally, although not illustrated in FIG. 1B for simplicity, the industrial controller 112 is also communicatively coupled to the machines 102D and 102E, the conveyors 104D and 104F, and the bal-ancer/joiner 118 for monitoring and control in the manner described above.

The configuration shown in FIG. 1B is commonly referred to as a parallel manufacturing line since items 110 progress through the machines 102 on parallel manufacturing lines 100A and 100B before merging. In this regard, it is to be appreciated that the manufacturing lines 100 shown in FIGS. 1A and 1B and described above are merely illustrative and that other configurations can be utilized with the technologies disclosed herein. It should also be appreciated that the manufacturing lines shown in FIGS. 1A and 1B have been simplified for discussion purposes and that in an actual implementation of the lines 100 would likely include many more components known to those skilled in the art.

As discussed briefly above, optimizing the efficiency of manufacturing lines 100 such as those described above, and others, can be extremely challenging due to the many variables present in many types of manufacturing processes. For instance, machines 102 operating on manufacturing lines 100 can have many settings, including a speed of operation setting. Machines 102 on manufacturing lines 100 can also periodically become jammed or otherwise malfunction. Conveyors 104 and other components on manufacturing lines 100 can also have their own settings and can also periodically malfunction or become inoperable.

Current processes for operating many types of manufacturing lines 100, such as those described above, commonly rely on manual input from operators to deal with jammed or malfunctioning machines 102 and to keep manufacturing lines 100 operating in an optimal fashion. For example, when a machine 102 on a manufacturing line 100 becomes jammed or is otherwise malfunctioning, a human operator might manually adjust the speed of operation of another machine 102 that is upstream from the jammed or malfunctioning machine 102 in order to slow the influx of items 110 into the jammed or malfunctioning machine 102 while the operator addresses the jam or malfunction.

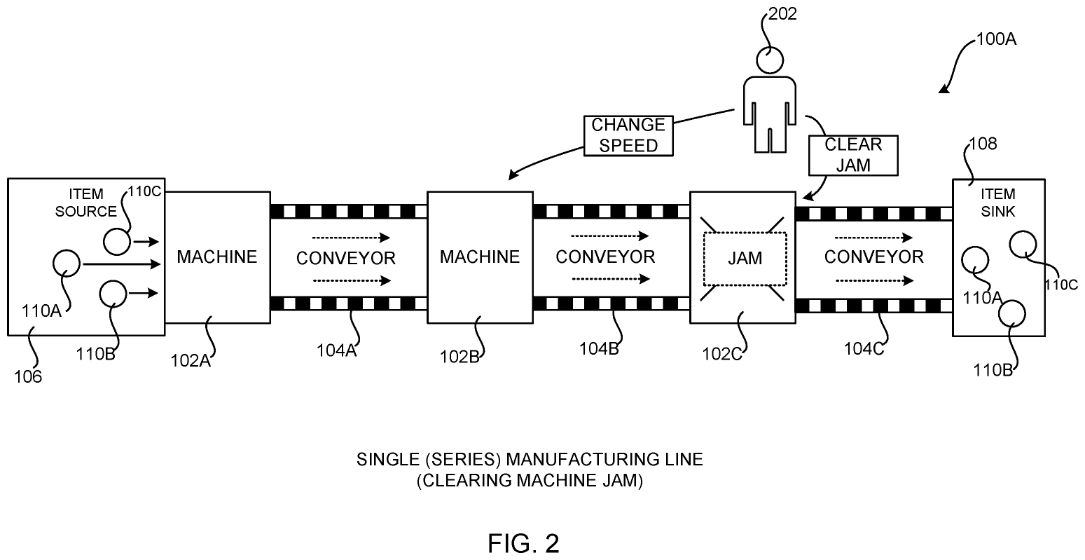

In the example illustrated in FIG. 2, for instance, the machine 102C has become jammed (or is otherwise malfunctioning). In order to slow the ingress of items 110 onto the conveyer 104B so that they can clear the jam or otherwise address the malfunction, an operator 202 may place the machine 102C in an idle state and manually reduce the speed of the machine 102B. As discussed above, these types of manual adjustments are typically very localized and, as a result, change only the operating speed of machines 102 proximate to a jammed or otherwise malfunctioning machine 102.

Consequently, manual adjustments such as these that are made in response to jams or other malfunctions on a manufacturing line 100 are typically sub-optimal, which can result manufacturing lines 100 operating in an inefficient manner, and thereby producing fewer items 110 than they are otherwise capable of. It is with respect to these and other technical challenges that the technologies described below are presented.

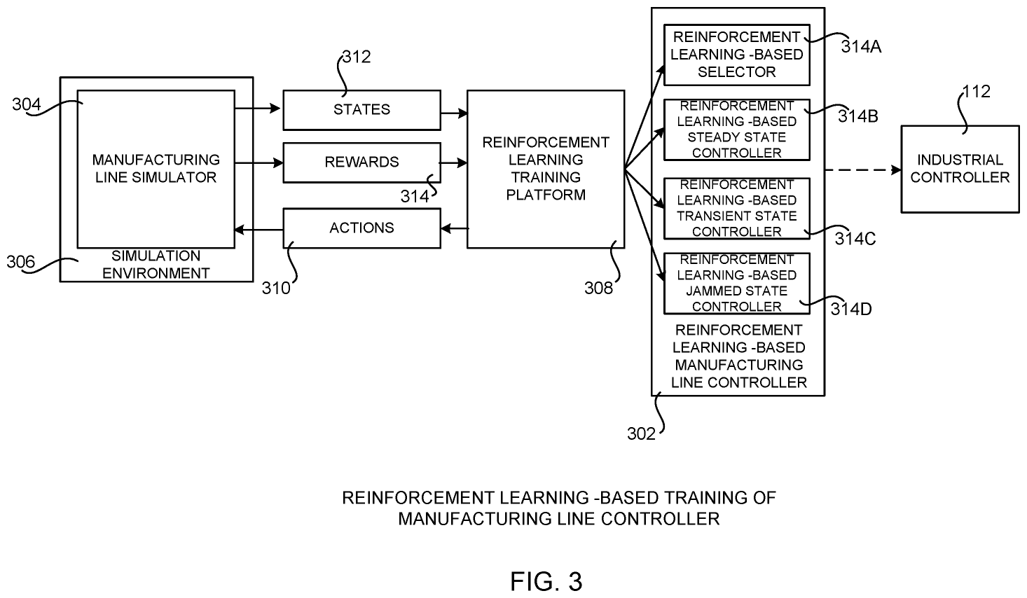

FIG. 3 is a software architecture diagram illustrating aspects of reinforcement learning-based training of a reinforcement learning-based manufacturing line controller 302, according to one embodiment disclosed herein. As will be described in greater detail below, the reinforcement learning-based manufacturing line controller 302 (which might be referred to herein simply as the “manufacturing line controller 302”) is a software component in one embodiment that can be deployed to and executed on the industrial controller 112 to control aspects of the operation of a manufacturing line 100 such as those shown in FIGS. 1A and 1B and described above.

In order to train the manufacturing line controller 302, a manufacturing line simulator 304 is created that models the operation of a physical manufacturing line 100, such as those shown in FIGS. 1A and 1B and described above. For example, the manufacturing line simulator 304 might simulate the operation of the machines 102, the conveyors 104, the discharge sensors 114, the infeed sensors 116, and other components of a manufacturing line 100 in a virtual environment.

The manufacturing line simulator 304 can be programmed to simulate the operation of a manufacturing line 100 such as, for example, by modeling the flow of items 110 through the line 100. The manufacturing line simulator 304 can also be programmed to simulate downtime of the physical manufacturing line upon which it is based. For instance, data describing the historical downtime of the corresponding physical manufacturing line might be analyzed to compute the mean downtime duration and the maximum downtime duration for the physical manufacturing line. These parameters can be utilized by the manufacturing line simulator 304 as proxies for downtime of the simulated manufacturing line.

The manufacturing line simulator 304 might be created in an appropriate programming or simulation environment 306. For example, in one particular embodiment, the manufacturing line simulator 304 is created using the Python programming language. Other types of programming or simulation environments 306 can be utilized in other embodiments.

The manufacturing line simulator 304 can be utilized in conjunction with a reinforcement learning training platform 308 to utilize reinforcement learning to train several components to control various aspects of a manufacturing line 100. In particular, the manufacturing line simulator 304 and the reinforcement learning training platform 308 are utilized to train the manufacturing line controller 302 in one embodiment. Details regarding this process will be provided below.

In one embodiment, the reinforcement learning training platform 308 is the PROJECT BONSAI low-code artificial intelligence (“AI”) development platform for intelligent control systems from MICROSOFT CORPORATION of Redmond, Wash. In this regard, it is to be appreciated that other platforms can be utilized to perform reinforcement learning training of the manufacturing line controller 302 in other embodiments.

As will be described in greater detail below, once trained, the manufacturing line controller 302 can be deployed to and executed on an industrial controller 112, or another type of computing device communicatively coupled to the machines 102 and other components on a physical manufacturing line 100, to control various aspects of the operation of the manufacturing line 100. For example, and without limitation, the manufacturing line controller 302 can be trained utilizing reinforcement learning to control the operating speeds of machines 102 on a manufacturing line 100 in order to optimize the output of items 110 from the manufacturing line 100.

As illustrated in FIG. 3, in one particular embodiment the manufacturing line controller 302 includes a reinforcement learning-based selector 314A (which might be referred to herein simply as “the selector 314A”), a reinforcement learning-based steady state controller (which might be referred to herein simply as “the steady state controller 314B”), a reinforcement learning-based transient state controller (which might be referred to herein simply as “the transient state controller 314C”), and a reinforcement learning-based jammed state controller (which might be referred to herein simply as “the jammed state controller 314D”).

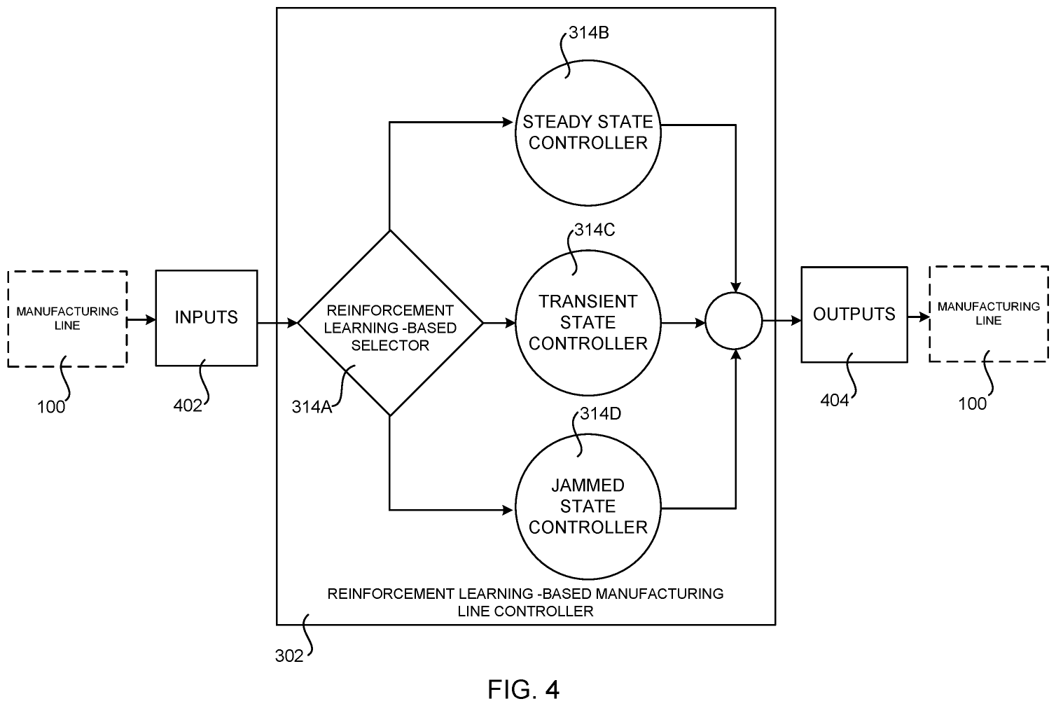

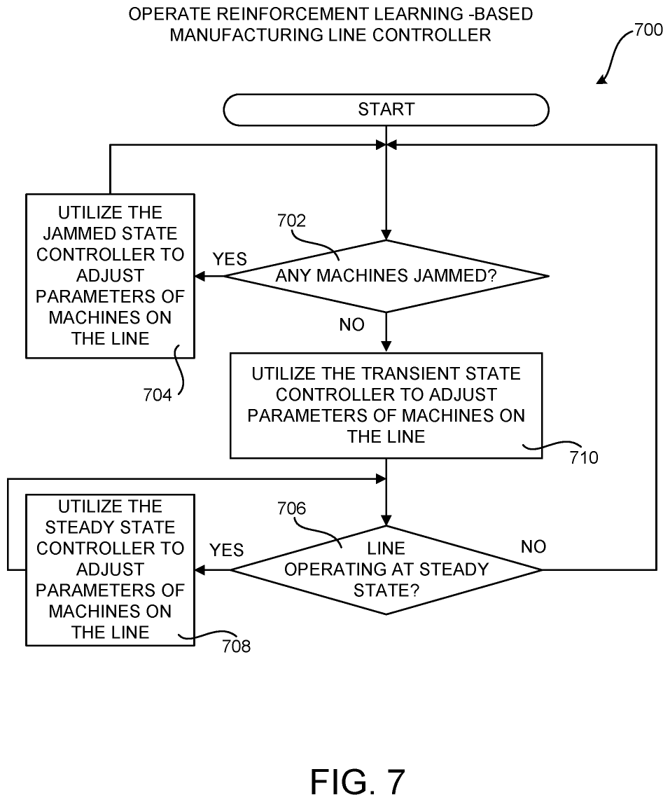

The selector 314A and the controllers 314B-314D are trained using the manufacturing line simulator 304 and the reinforcement learning training platform 306. As will be described in greater detail below with respect to FIGS. 4 and 7, the selector 314A is trained using reinforcement learning to utilize inputs received from the machines 102, proximity sensors, and other components on a manufacturing line 100 to select one of the controllers 314B-314D identified above at a given time to operate the manufacturing line 100 in the most appropriate manner.

As discussed briefly above, the reinforcement learning training platform 308 utilizes reinforcement learning to train the selector 314A and the controllers 314B-314D that comprise the manufacturing line controller 302. As known to those skilled in the art, reinforcement learning trains an agent (i.e., the selector 314A and the controllers 314B-314D in the illustrated embodiment) to maximize an overall reward 314 through the exploration of the quality of new states 312 achieved through taking actions 310.

In the disclosed embodiments, the selector 314A and the controllers 314B-314D are trained separately but in a similar manner utilizing different rewards 314. The training process can be repeated many thousands, hundreds of thousands, or even millions of times.

In the example illustrated in FIG. 3, the actions 310 provided by the reinforcement learning training platform 308 to the manufacturing line simulator 304 are operating speeds of the simulated machines on the manufacturing line simulated by the manufacturing line simulator 304. In this manner, by varying the actions 310, the reinforcement learning training platform 308 can adjust the operating speeds of the machines 102 on the simulated manufacturing line and, accordingly, vary the output of the simulated manufacturing line. Other actions 310 can be utilized in other embodiments.

As discussed briefly above, the states 312 are various parameters, or outputs, describing current operating conditions of the on the manufacturing line simulated by the manufacturing line simulator 304. For example, and without limitation, the states 312 might describe the current operating speeds of the machines in the simulated manufacturing line, the status of machines on the simulated manufacturing line (e.g., whether a machine is jammed or is otherwise malfunctioning), the estimated number of items 100 on the conveyors in the simulated manufacturing line, the offset from the mean downtime duration described above, the offset from the maximum downtime duration described above, the status of sensors on the simulated manufacturing line, and other parameters describing the current operating condition of the simulated manufacturing line.

In one particular embodiment the manufacturing line simulator 304 re-turns a status for states 312 indicating whether the machines 102 are “running” or are “down” (i.e. not running). Some actions 310 result in more frequent “running” status and some actions 310 result in more “down” status. Rewards 314 for actions 310 that result in more “running” status are valued more highly than actions 310 that result in more “down” status in this embodiment.

The rewards 314 utilized during training can vary depending upon which component is being trained. For example, and without limitation, the reward 314 utilized during training of the steady state controller 314B is the maximization of the total number of items 110 produced by the manufacturing line 100 and minimization of the number of machines 102 that are shut down (and put into idle mode) due over or under loading the conveyors 104. The reward 314 utilized during training of the transient state controller 314C is maximization of the speed at which the manufacturing line 100 can return to the steady state of operation. The reward 314 utilized during training of the jammed state controller 314D is based upon maintaining the operation of non-jammed machines and avoiding the shutting down of non-jammed machines (e.g. due to over- or under-loading of a conveyor 104). Additional details regarding the training process are provided below.

FIG. 4 is a state diagram illustrating aspects of the operation of the selector 314A for selecting a reinforcement learning-based controller 314B-314D for controlling the operation of the machines 102 on a manufacturing line 100, according to one embodiment disclosed herein. As discussed above, once the components of the reinforcement learning-based manufacturing line controller 302 have been trained using reinforcement learning, it can be deployed to an industrial controller 112 or another type of computing device that is communicatively coupled to the machines 102 on a manufacturing line 100.

Once deployed, the reinforcement learning-based manufacturing line controller 302 can be executed on the industrial controller 112 and begin receiving inputs 402 from the machines 102, conveyors 104, discharge sensors 114, infeed sensors 116, and other sensors or components on the manufacturing line 100. As discussed briefly above, the inputs 402 indicate aspects of the operating state of the manufacturing line 100. For example, and without limitation, the reinforcement learning-based manufacturing line controller 302 might receive inputs 402 indicating the actual operating speed of the machines 102 on the line 100, the current status of the machines 102 on the line 100 (e.g. whether a machine is jammed or is otherwise malfunctioning), the estimated number of items at various locations on conveyor belts 104 in the manufacturing line 100, the status of various proximity sensors 114 and 116 on the manufacturing line 100, and other types of data.

In response to receiving inputs 402 such as those described above, the reinforcement learning-based selector 314A selects one of the reinforcement learning-based controllers 314B-314D described above for controlling the operation of the machines 102 on the manufacturing line 100 based on the inputs 402. For example, and without limitation, the reinforcement learning-based selector 314A might select the steady state controller 314B, the transient state controller 314C, or the jammed state controller 314D to control the operation of the machines 102 on the manufacturing line 100 at a given time based on the state of the inputs 402.

Once the reinforcement learning-based selector 314A has selected one of the controllers 314B-314D, the selected controller 314B-314D is executed on the industrial controller 112. In operation, the selected controller 314B-314D generates outputs 404 (e.g., an output 404 to adjust the operating speed for a particular machine 102 on the manufacturing line 100) that are provided as input to the machines 102 for controlling the operation of the machines 102 on the manufacturing line 100.

The reinforcement learning-based selector 314A continually monitors outputs (i.e. inputs 402) generated by the machines 102, conveyors 104, discharge sensors 114, infeed sensors 116, and other sensors or components on the manufacturing line 100 to ensure that the most optimal controller 314B-314D is being utilized to control the operation of the line 100. For example, and without limitation, if the reinforcement learning-based selector 314A receives an input 402 indicating that one or more of the machines 102 on the manufacturing line 100 is jammed or is otherwise malfunctioning, the reinforcement learning-based selector 314A will select the jammed state controller 314D for controlling the operation of the machines on the line 100. As discussed briefly above, the jammed state controller 314D is trained to adjust outputs 404 that are provided as inputs to the machines 102 on the manufacturing line 100 to reduce the operating speed of one or more of the machines 102 on the manufacturing line 100 until none of the machines 102 on the manufacturing line 100 is jammed or malfunctioning.

Similarly, if the reinforcement learning-based selector 314A receives inputs 402 indicating that none of the machines 102 on the manufacturing line 100 is jammed or otherwise malfunctioning but that the manufacturing line 100 is not operating in a steady state of operation, the reinforcement learning-based selector 314A will select the transient state controller 314C for controlling the operation of the machines 102 on the line 100. The transient state controller 314C is trained to generate outputs 404 to one or more of the machines 102 on the manufacturing line 100 instructing them to adjust their operating speeds until the manufacturing line 100 is operating in the steady state of operation.

If the reinforcement learning-based selector 314A receives inputs 402 indicating that none of the machines 102 on the manufacturing line 100 is jammed or otherwise malfunctioning and the manufacturing line 100 is operating in a steady state of operation, the reinforcement learning-based selector 314A will select the steady controller 314B. The controller 314B is configured to maintain operation of the manufacturing line 100 in the steady state of operation until a machine jams or malfunctions or another event occurs that causes the manufacturing line 100 to stop operating in the steady state of operation. The steady state of operation is a state in which all of the machines on a manufacturing line 100 are operating at an optimal speed without over-loading or under-loading the conveyors 104. In this state there is a consistent flow of items 110 produced and moved along the line 100. This optimal speed is determined by the trained steady state controller 314B.

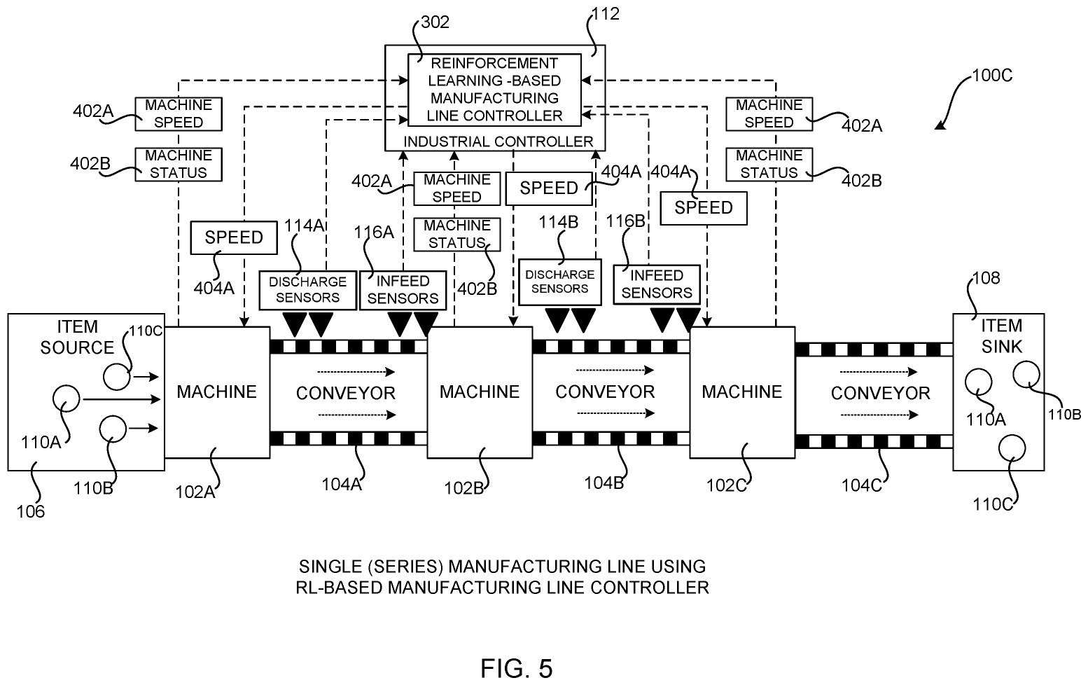

If an event (e.g., a machine 102 becoming jammed or malfunctioning) occurs that causes a manufacturing line 100 to stop operating in the steady state of operation, the reinforcement learning-based selector 314A will select a new controller 314B-314D for controlling the operation of the machines 102 on the manufacturing line 100 based upon the current state of the inputs 402. Additional details regarding the operation of the reinforcement learning-based manufacturing line controller 302 will be provided below with regard to FIG. 5.

FIG. 5 is a manufacturing line diagram that shows aspects of a manufacturing line 100C that incorporates aspects of the technologies disclosed herein for reinforcement learning-based control of a manufacturing line 100, according to one em-bodiment disclosed herein. As shown in FIG. 5, the trained reinforcement learning-based manufacturing line controller 302 has been deployed to the industrial controller 112 in the illustrated example.

As also shown in FIG. 5 and discussed above, the manufacturing line controller 302 receives inputs 402 from the machines 102, conveyors 104, sensors 114 and 116, and/or other components on the manufacturing line 100C. For example, and without limitation, the manufacturing line controller 302 might receive inputs 402A indicating the speed of the machines 102A-102C, inputs 402B indicating the status of the machines 102A-102C (e.g., an indication if a machine 102 is jammed or malfunctioning), inputs indicating the presents of items 110 at various locations on the conveyors 104, and/or other types of inputs 402.

As also discussed above, the inputs 402 are provided to the selector 314A which, in turn, utilizes the inputs to select one of the controllers 314B-314D for controlling the operation of the manufacturing line 100C by generating appropriate outputs 404 that are provided to the machines 102. As discussed above, the outputs 404 might be, for example, outputs 404A adjusting the operating speed for one or more of the machines 102 on the manufacturing line 100C. Other types of outputs for controlling other parameters of the machines 102 can be provided in other embodiments. Additional details regarding the process illustrated in FIG. 5 will be provided below with regard to FIG. 7.

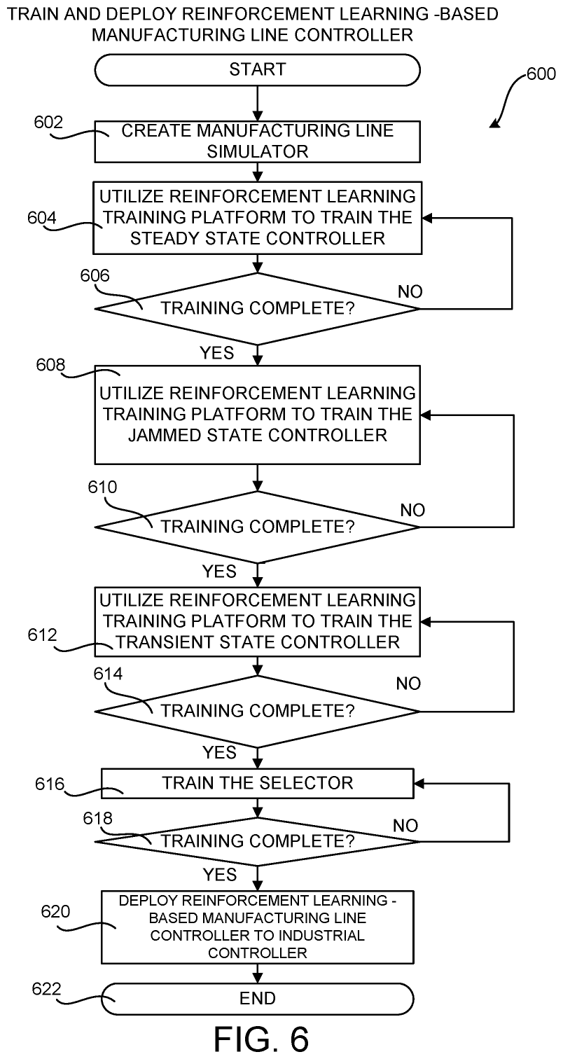

FIG. 6 is a flow diagram showing a routine 600 that illustrates aspects of the mechanism shown in FIG. 3 for reinforcement learning-based training of a selector 314A and several controllers 314B-314D, according to one embodiment disclosed herein. It should be appreciated that the logical operations described herein with regard to FIG. 6, and the other FIGS., can be implemented (1) as a sequence of com-puter implemented acts or program modules running on a computing device and/or (2) as interconnected machine logic circuits or circuit modules within a computing device.

The particular implementation of the technologies disclosed herein is a matter of choice dependent on the performance and other requirements of the computing device. Accordingly, the logical operations described herein are referred to vari-ously as states, operations, structural devices, acts, or modules. These states, operations, structural devices, acts and modules can be implemented in hardware, software, firmware, in special-purpose digital logic, and any combination thereof. It should be appreciated that more or fewer operations can be performed than shown in the FIGS. and described herein. These operations can also be performed in a different order than those described herein.

The routine 600 begins at operation 602, where the manufacturing line simulator 304 is created and deployed to the simulation environment 306 in the manner described above. As discussed above, the manufacturing line simulator 304 might be created in an appropriate programming or simulation environment 306. For example, and without limitation, in one particular embodiment the manufacturing line simulator 304 is created using the PYTHON programming language. Other types of programming or simulation environments 306 can be utilized in other embodiments.

From operation 602, the routine 600 proceeds to operation 604, where the manufacturing line simulator 304 and the reinforcement learning training platform 308 utilize reinforcement learning to train the steady state controller 314B in the manner described above. Once training of the steady state controller 314B has completed, the routine 600 proceeds from operation 606 to operation 608.

At operation 608, the manufacturing line simulator 304 and the reinforcement learning training platform 308 utilize reinforcement learning to train the jammed state controller 314D in the manner described above. Once training of the jammed state controller 314D has completed, the routine 600 proceeds from operation 610 to operation 612.

At operation 612, the manufacturing line simulator 304 and the reinforcement learning training platform 308 utilize reinforcement learning to train the transient state controller 314C in the manner described above. Once training of the transient state controller 314C has completed, the routine 600 proceeds from operation 614 to operation 616.

At operation 616, the manufacturing line simulator 304 and the reinforcement learning training platform 308 utilize reinforcement learning to train the selector 314A in the manner described above. Once training of the selector 314A has completed, the routine 600 proceeds from operation 618 to operation 620.

At operation 620, the reinforcement learning-based manufacturing line controller 302, including the selector 314A, the steady state controller 314B, the transient state controller 314C, and the jammed state controller 314D, are deployed to the industrial controller 112. Thereafter, the reinforcement learning-based manufacturing line controller 302 can be executed on the industrial controller 112 to control the operation of a manufacturing line 100 in the manner described above and in further detail below with regard to FIG. 7.

FIG. 7 is a flow diagram showing a routine 700 that illustrates aspects of the mechanism shown in FIG. 5 for operating a manufacturing line 100 utilizing the reinforcement learning-based manufacturing line controller 302, according to one em-bodiment disclosed herein. The routine 700 begins at operation 702, where the selector 314A determines if any machines 102 on the manufacturing line 100 are currently jammed. If so, the routine 700 proceeds from operation 702 to operation 704, where the selector 314A causes the industrial controller 112 to utilize the jammed state controller 314D to adjust the outputs 404 that are provided as inputs to the machines 102 on the line 100 to control their operation. For example, and as discussed above, the jammed state controller 314D might reduce the operating speed of machines on the line 100 until no machines 102 are jammed. From operation 704, the routine 700 continues back to operation 702.

If, at operation 702, the selector 314A determines if no machines 102 on the manufacturing line 100 are currently jammed, the routine 700 proceeds from operation 700 to operation 710. At operation 710, the selector 314A causes the industrial controller 112 to utilize the transient state controller 314C to control the outputs 404 that are provided to the machines 102 on the line 100 to control their operation. For example, and as discussed above, the transient state controller 314C might increase the operating speed of machines 102 on the line 100 until the manufacturing line 100 reaches the steady state of operation.

The routine 700 proceeds from operation 710 to operation 706, where the selector 314A determines if the manufacturing line 100 is operating at a steady state. If no machines 102 are jammed (i.e., as determined at operation 702) and the line 100 is operating at in the steady state of operation, the routine 700 proceeds from operation 706 to operation 708. At operation 708, the selector 314A causes the industrial controller 112 to utilize the steady state controller 314B to control the outputs 404 that are provided to the machines 102 on the line 100 to control their operation. From operation 708, the routine 700 proceeds back to operation 706. If, however, the selector 314A determines at operation 706 that the manufacturing line 100 is not operating in the steady state of operation, the routine 700 proceeds from operation 706 back to operation 702, described above.

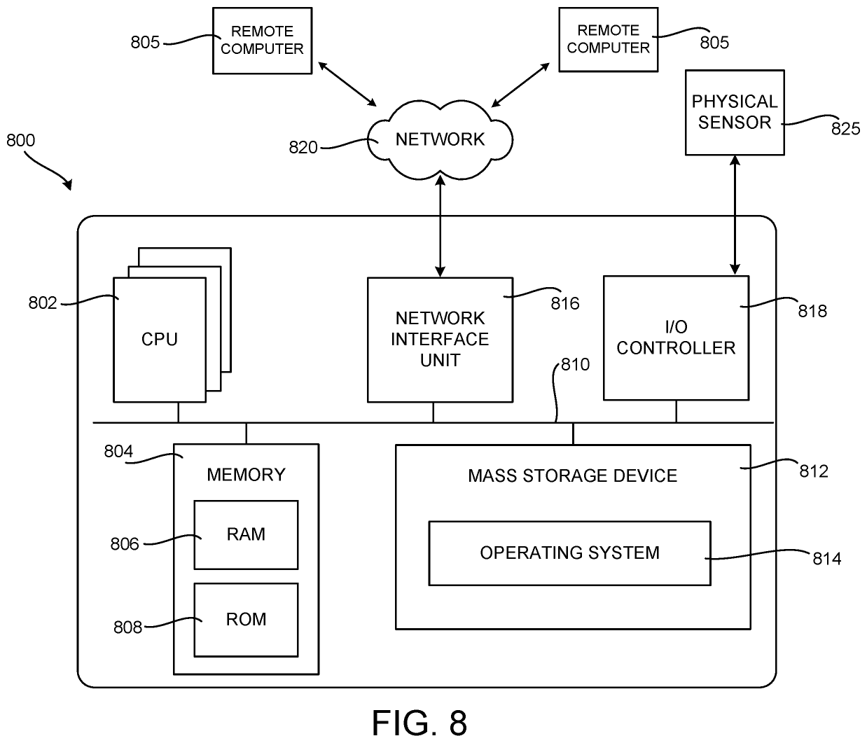

FIG. 8 is a computer architecture diagram showing an illustrative com-puter hardware and software architecture for a computing device 800 that can implement the various technologies presented herein. For example, and without limitation, the computer architecture shown in FIG. 8 might be utilized to implement the industrial controller 112 shown in the FIGS. and described above. The computer architecture shown in FIG. 8 might also be utilized to implement a computing device 800 for executing the simulation environment 306 and/or the reinforcement learning training platform 308.

The computing device 800 illustrated in FIG. 8 includes a central processing unit 802 (“CPU”), a system memory 804, including a random-access memory 806 (“RAM”) and a read-only memory (“ROM”) 808, and a system bus 810 that couples the memory 804 to the CPU 802. A basic input/output system (“BIOS” or “firmware”) containing the basic routines that help to transfer information between elements within the computing device 800, such as during startup, can be stored in the ROM 808. The computing device 800 further includes a mass storage device 812 for storing an operating system 102, application programs, and other types of programs. The mass storage device 812 can also be configured to store other types of programs and data such as, but not limited to, the reinforcement learning-based manufacturing line controller 302.

The mass storage device 812 is connected to the CPU 802 through a mass storage controller (not shown) connected to the bus 810. The mass storage device 812 and its associated computer readable media provide non-volatile storage for the computing device 800. Although the description of computer readable media contained herein refers to a mass storage device, such as a hard disk, CD-ROM drive, DVD-ROM drive, or USB storage key, it should be appreciated by those skilled in the art that computer readable media can be any available computer storage media or communication media that can be accessed by the computing device 800.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or di-rect-wired connection, and wireless media such as acoustic, radio frequency, infrared and other wireless media. Combinations of the any of the above should also be included within the scope of computer readable media.

By way of example, and not limitation, computer storage media can include volatile and non-volatile, removable and non-removable media implemented in any method or technology for storage of information such as computer readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computing device 800. For purposes of the claims, the phrase “computer storage medium,” and variations thereof, does not include waves or signals per se or communication media.

According to various configurations, the computing device 800 can operate in a networked environment using logical connections to remote computers through a network such as the network 820. The computing device 800 can connect to the network 820 through a network interface unit 816 connected to the bus 810. It should be appreciated that the network interface unit 816 can also be utilized to connect to other types of networks and remote computer systems not shown in FIG. 8.

The computing device 800 can also include an input/output controller 818 for receiving and processing input from a number of other devices, including a keyboard, mouse, touch input, an electronic stylus (not shown in FIG. 8), or a physical sensor such as a video camera. Similarly, the input/output controller 818 can provide output to a display screen or other type of output device (also not shown in FIG. 8).

It should be appreciated that the software components described herein, when loaded into the CPU 802 and executed, can transform the CPU 802 and the overall computing device 800 from a general-purpose computing device into a special-purpose computing device customized to facilitate the functionality presented herein. The CPU 802 can be constructed from any number of transistors or other discrete circuit elements, which can individually or collectively assume any number of states. More specifically, the CPU 802 can operate as a finite-state machine, in response to executable instructions contained within the software modules disclosed herein. These computer-executable instructions can transform the CPU 802 by specifying how the CPU 802 transitions between states, thereby transforming the transistors or other discrete hardware elements constituting the CPU 802.

Encoding the software modules presented herein can also transform the physical structure of the computer readable media presented herein. The specific trans-formation of physical structure depends on various factors, in different implementations of this description. Examples of such factors include, but are not limited to, the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computing device 800 in order to store and execute the software components presented herein. It also should be appreciated that the architecture shown in FIG. 8 for the computing device 800, or a similar architecture, can be utilized to implement other types of computing devices known to those skilled in the art. It is also contemplated that the computing device 800 might not include all of the components shown in FIG. 8, can include other components that are not explicitly shown in FIG. 8, or can utilize an architecture completely different than that shown in FIG. 8.

It should also be appreciated that the computing architecture shown in FIG. 8 has been simplified for ease of discussion. It should be further appreciated that the computing architecture and the distributed computing network can include and utilize many more computing components, devices, software programs, networking devices, and other components not specifically described herein.

The disclosure presented herein also encompasses the subject matter set forth in the following clauses:

Clause 1. A computer-implemented method, comprising: executing a reinforcement learning-based selector on an industrial controller, the industrial controller communicatively coupled to a plurality of machines on a manufacturing line; receiving, at the reinforcement learning-based selector, one or more inputs describing an operating state of the plurality of machines on the manufacturing line; selecting, by way of the reinforcement learning-based selector, one of a plurality of reinforcement learning-based controllers for controlling operation of the plurality of machines on the manufacturing line, the selection made based at least in part on the one or more inputs; and executing the selected one of the plurality of reinforcement learning-based controllers on the industrial controller, the selected one of the plurality of reinforcement learning-based controllers configured to generate one or more outputs for controlling the operation of the plurality of machines on the manufacturing line.

Clause 2. The computer-implemented method of clause 1, wherein the selecting is based, at least in part, on whether the one or more inputs indicate that one or more of the plurality of machines on the manufacturing line is jammed.

Clause 3. The computer-implemented method of any of clauses 1 or 2, wherein, in response to determining that the one or more inputs indicate that one or more of the plurality of machines on the manufacturing line is jammed, the reinforcement learning-based selector is configured to select a reinforcement learning-based controller configured to generate outputs to adjust an operating speed of one or more of the plurality of machines on the manufacturing line until none of the plurality of machines on the manufacturing line is jammed.

Clause 4. The computer-implemented method of any of clauses 1-3, wherein the selecting is based, at least in part, on whether one or more inputs indicate that the manufacturing line is operating in a steady state of operation.

Clause 5. The computer-implemented method of any of clauses 1-4, wherein, in response to determining that the one or more inputs indicates that none of the plurality of machines on the manufacturing line is jammed and the manufacturing line is not operating in a steady state of operation, the reinforcement learning-based selector is configured to select a reinforcement learning-based controller configured to generate outputs to adjust an operating speed of one or more of the plurality of machines on the manufacturing line until the manufacturing line is operating in the steady state of operation.

Clause 6. The computer-implemented method of any of clauses 1-5, wherein, in response to determining that the one or more inputs indicates that none of the plurality of machines on the manufacturing line is jammed and the manufacturing line is operating in a steady state of operation, the reinforcement learning-based selector is configured to select a reinforcement learning-based controller configured to maintain operation of the manufacturing line in the steady state of operation.

Clause 7. The computer-implemented method of any of clauses 1-6, wherein the reinforcement learning-based selector and the plurality of reinforcement learning-based controllers are trained utilizing reinforcement learning using a simulation of the manufacturing line.

Clause 8. A computer-readable storage medium having computer-executable instructions stored thereupon which, when executed by a computing device, cause the computing device to: select, by way of a reinforcement learning-based selector, one of a plurality of reinforcement learning-based controllers for controlling operation of a plurality of machines on a manufacturing line; and execute the selected one of the plurality of reinforcement learning-based controllers on an industrial controller communicatively coupled to the plurality of machines, the selected one of the plurality of reinforcement learning-based controllers configured to generate one or more outputs for controlling the operation of the plurality of machines.

Clause 9. The computer-readable storage medium of clause 8, wherein the selecting is based, at least in part, on whether one or more inputs received from the plurality of machines indicates that one or more of the plurality of machines on the manufacturing line is jammed.

Clause 10. The computer-readable storage medium of any of clauses 8 or 9, wherein the reinforcement learning-based selector is configured to select a reinforcement learning-based controller configured to generate outputs to adjust an operating speed of one or more of the plurality of machines on the manufacturing line until none of the plurality of machines on the manufacturing line is jammed when the one or more inputs received from the plurality of machines indicates that one or more of the plurality of machines on the manufacturing line is jammed.

Clause 11. The computer-readable storage medium of any of clauses 8-10, wherein the selecting is based, at least in part, on whether one or more inputs indicate that the manufacturing line is operating in a steady state of operation.

Clause 12. The computer-readable storage medium of any of clauses 8-11, wherein the reinforcement learning-based selector is configured to select a reinforcement learning-based controller configured to generate outputs to adjust an operating speed of one or more of the plurality of machines on the manufacturing line until the manufacturing line is operating in the steady state of operation when the one or more inputs indicates that none of the plurality of machines on the manufacturing line is jammed and the manufacturing line is not operating in the steady state of operation.

Clause 13. The computer-readable storage medium of any of clauses 8-12, the reinforcement learning-based selector is configured to select a reinforcement learning-based controller configured to maintain operation of the manufacturing line in the steady state of operation when the one or more inputs indicates that none of the plurality of machines on the manufacturing line is jammed and the manufacturing line is operating in the steady state of operation.

Clause 14. The computer-readable storage medium of any of clauses 8-13, wherein the reinforcement learning-based selector and the plurality of reinforcement learning-based controllers are trained utilizing reinforcement learning using a simulation of the manufacturing line.

Clause 15. A computing device, comprising: at least one processor; and a computer-readable storage medium having computer-executable instructions stored thereupon which, when executed by the at least one processor, cause the computing device to: execute a reinforcement learning-based selector trained to select one of a plurality of reinforcement learning-based controllers for controlling operation of a plurality of machines on a manufacturing line; and execute the selected one of the plurality of reinforcement learning-based controllers, the selected one of the plurality of reinforcement learning-based controllers configured to generate one or more outputs for controlling the operation of the plurality of machines.

Clause 16. The computing device of clause 15, wherein the com-puter-readable storage medium has further computer-executable instructions stored thereupon to: receive, at the reinforcement learning-based selector, one or more inputs describing an operating state of the plurality of machines on the manufacturing line; and select, by way of the reinforcement learning-based selector, one of the plurality of reinforcement learning-based controllers for controlling operation of the plurality of machines on the manufacturing line based at least in part on the one or more inputs.

Clause 17. The computing device of any of clauses 15 or 16, wherein the selecting is based, at least in part, on whether the one or more inputs indicate that one or more of the plurality of machines on the manufacturing line is jammed

Clause 18. The computing device of any of clauses 15-17, wherein the reinforcement learning-based selector is configured to select a reinforcement learning-based controller configured to generate outputs to adjust an operating speed of one or more of the plurality of machines on the manufacturing line until none of the plurality of machines on the manufacturing line is jammed when the one or more inputs indicates that one or more of the plurality of machines on the manufacturing line is jammed.

Clause 19. The computing device of any of clauses 15-18, wherein the selecting is based, at least in part, on whether one or more inputs indicate that the manufacturing line is operating in a steady state of operation.

Clause 20. The computing device of any of clauses 15-19, wherein the reinforcement learning-based selector is configured to select a reinforcement learning-based controller configured to generate outputs to adjust an operating speed of one or more of the plurality of machines on the manufacturing line until the manufacturing line is operating in the steady state of operation when the one or more inputs indicates that none of the plurality of machines on the manufacturing line is jammed and the manufacturing line is not operating in the steady state of operation.

Based on the foregoing, it should be appreciated that technologies for reinforcement learning-based optimization of manufacturing lines have been disclosed herein. Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

The subject matter described above is provided by way of illustration only and should not be construed as limiting. Various modifications and changes can be made to the subject matter described herein without following the example configurations and applications illustrated and described, and without departing from the scope of the present disclosure, which is set forth in the following claims.

What is claimed is:

1. A computer-implemented method, comprising:
executing a reinforcement learning-based selector on an industrial controller, the industrial controller communicatively coupled to a plurality of machines on a manufacturing line;
receiving, at the reinforcement learning-based selector, one or more inputs describing an operating state of the plurality of machines on the manufacturing line;
selecting, by way of the reinforcement learning-based selector, one of a plurality of reinforcement learning-based controllers for controlling operation of the plurality of machines on the manufacturing line, the selection made based at least in part on the one or more inputs; and
executing the selected one of the plurality of reinforcement learning-based controllers on the industrial controller, the selected one of the plurality of reinforcement learning-based controllers configured to generate one or more outputs for controlling the operation of the plurality of machines on the manufacturing line.

2. The computer-implemented method of claim 1, wherein the selecting is based, at least in part, on whether the one or more inputs indicate that one or more of the plurality of machines on the manufacturing line is jammed.

3. The computer-implemented method of claim 2, wherein, in response to determining that the one or more inputs indicate that one or more of the plurality of machines on the manufacturing line is jammed, the reinforcement learning-based selector is configured to select a reinforcement learning-based controller configured to generate outputs to adjust an operating speed of one or more of the plurality of machines on the manufacturing line until none of the plurality of machines on the manufacturing line is jammed.

4. The computer-implemented method of claim 1, wherein the selecting is based, at least in part, on whether one or more inputs indicate that the manufacturing line is operating in a steady state of operation.

5. The computer-implemented method of claim 4, wherein, in response to determining that the one or more inputs indicates that none of the plurality of machines on the manufacturing line is jammed and the manufacturing line is not operating in a steady state of operation, the reinforcement learning-based selector is configured to select a reinforcement learning-based controller configured to generate outputs to adjust an operating speed of one or more of the plurality of machines on the manufacturing line until the manufacturing line is operating in the steady state of operation.

6. The computer-implemented method of claim 4, wherein, in response to determining that the one or more inputs indicates that none of the plurality of machines on the manufacturing line is jammed and the manufacturing line is operating in a steady state of operation, the reinforcement learning-based selector is configured to select a reinforcement learning-based controller configured to maintain operation of the manufacturing line in the steady state of operation.

7. The computer-implemented method of claim 1, wherein the reinforcement learning-based selector and the plurality of reinforcement learning-based controllers are trained utilizing reinforcement learning using a simulation of the manufacturing line.

8. A computer-readable storage medium having computer-executable instructions stored thereupon which, when executed by a computing device, cause the computing device to:
select, by way of a reinforcement learning-based selector, one of a plurality of reinforcement learning-based controllers for controlling operation of a plurality of machines on a manufacturing line; and
execute the selected one of the plurality of reinforcement learning-based controllers on an industrial controller communicatively coupled to the plurality of machines, the selected one of the plurality of reinforcement learning-based controllers configured to generate one or more outputs for controlling the operation of the plurality of machines.

9. The computer-readable storage medium of claim 8, wherein the selecting is based, at least in part, on whether one or more inputs received from the plurality of machines indicates that one or more of the plurality of machines on the manufacturing line is jammed.

10. The computer-readable storage medium of claim 9, wherein the reinforcement learning-based selector is configured to select a reinforcement learning-based controller configured to generate outputs to adjust an operating speed of one or more of the plurality of machines on the manufacturing line until none of the plurality of machines on the manufacturing line is jammed when the one or more inputs received from the plurality of machines indicates that one or more of the plurality of machines on the manufacturing line is jammed.

11. The computer-readable storage medium of claim 8, wherein the selecting is based, at least in part, on whether one or more inputs indicate that the manufacturing line is operating in a steady state of operation.

12. The computer-readable storage medium of claim 11, wherein the reinforcement learning-based selector is configured to select a reinforcement learning-based controller configured to generate outputs to adjust an operating speed of one or more of the plurality of machines on the manufacturing line until the manufacturing line is operating in the steady state of operation when the one or more inputs indicates that none of the plurality of machines on the manufacturing line is jammed and the manufacturing line is not operating in the steady state of operation.

13. The computer-readable storage medium of claim 11, the reinforcement learning-based selector is configured to select a reinforcement learning-based controller configured to maintain operation of the manufacturing line in the steady state of operation when the one or more inputs indicates that none of the plurality of machines on the manufacturing line is jammed and the manufacturing line is operating in the steady state of operation.

14. The computer-readable storage medium of claim 8, wherein the reinforcement learning-based selector and the plurality of reinforcement learning-based controllers are trained utilizing reinforcement learning using a simulation of the manufacturing line.

15. A computing device, comprising:
at least one processor; and
a computer-readable storage medium having computer-executable instructions stored thereupon which, when executed by the at least one processor, cause the computing device to:
execute a reinforcement learning-based selector trained to select one of a plurality of reinforcement learning-based controllers for controlling operation of a plurality of machines on a manufacturing line; and
execute the selected one of the plurality of reinforcement learning-based controllers, the selected one of the plurality of reinforcement learning-based controllers configured to generate one or more outputs for controlling the operation of the plurality of machines.

16. The computing device of claim 15, wherein the computer-readable storage medium has further computer-executable instructions stored thereupon to:
receive, at the reinforcement learning-based selector, one or more inputs describing an operating state of the plurality of machines on the manufacturing line; and
select, by way of the reinforcement learning-based selector, one of the plurality of reinforcement learning-based controllers for controlling operation of the plurality of machines on the manufacturing line based at least in part on the one or more inputs.

17. The computing device of claim 16, wherein the selecting is based, at least in part, on whether the one or more inputs indicate that one or more of the plurality of machines on the manufacturing line is jammed.

18. The computing device of claim 17, wherein the reinforcement learning-based selector is configured to select a reinforcement learning-based controller configured to generate outputs to adjust an operating speed of one or more of the plurality of machines on the manufacturing line until none of the plurality of machines on the manufacturing line is jammed when the one or more inputs indicates that one or more of the plurality of machines on the manufacturing line is jammed.

19. The computing device of claim 15, wherein the selecting is based, at least in part, on whether one or more inputs indicate that the manufacturing line is operating in a steady state of operation.

20. The computing device of claim 19, wherein the reinforcement learning-based selector is configured to select a reinforcement learning-based controller configured to generate outputs to adjust an operating speed of one or more of the plurality of machines on the manufacturing line until the manufacturing line is operating in the steady state of operation when the one or more inputs indicates that none of the plurality of machines on the manufacturing line is jammed and the manufacturing line is not operating in the steady state of operation.
